(19) United States
(12) Patent Application Publication
(10) Pub. No.: US 2010/0294800 A1
(43) Pub. Date: Nov. 25, 2010

(54) PORTABLE ELECTRICAL LIQUID DISPENSING APPARATUS

(75) Inventors: Keh-Chi Tsai, Saratoga, CA (US); Wen-Hua Lin, Yilan County (TW)

Correspondence Address: PAI PATENT & TRADEMARK LAW FIRM, 1001 FOURTH AVENUE, SUITE 3200, SEATTLE, WA, 98154, US

(73) Assignees: NATIONAL ENERGY TECHNOLOGY CO., LTD., Tucheng City (TW); APOGEE POWER, INC., Campbell, CA (US)

(21) Appl. No.: 12/468,059

(22) Filed: May 19, 2009

(51) Int. Cl. F15C 4/00

(52) U.S. Cl. 222/52

(57) ABSTRACT

A portable electrical liquid dispensing apparatus includes a housing, a power supply detachably connected with the housing, a driving unit accommodated in the housing and electrically connected with the power supply, a liquid dispensing unit accommodated in the housing and coupled to the driving unit, a first dispensing pipe having a first entry end and a first exhaust end connected with the liquid dispensing unit, and a second dispensing pipe having a second entry end connected with the liquid dispensing unit and a second exhaust end. When the electrical liquid dispensing apparatus is used, the liquid dispensing unit can be driven by the driving unit to dispense the fuel from a fuel tank into an agricultural machine through the first dispensing pipe and the second dispensing pipe, thereby enhancing the efficiency and convenience of refueling operation.

### BACKGROUND OF THE INVENTION

1. Field of the Invention

The present invention relates generally to a liquid dispensing apparatus, and more specifically to an electrical liquid dispensing apparatus that is portable to enhance the efficiency and convenience of refueling operation.

2. Description of the Related Art

Agriculture has played a key role in the development of human civilization, and the agricultural techniques has been developing steadily, particularly in mechanization.

Due to the agricultural mechanization, a cultivator will operate an agricultural machine to cultivate, fertilize and seed land, and spray and harvest crops, thereby increasing farm efficiency and productivity. However, the agricultural machine needs to be refueled when it is used for a period of time, and therefore the cultivator will built a plurality of fuel tanks around the land so as to refuel the agricultural machine at any time.

When refueling the agricultural machine, the cultivator has to operate a manual fuel extractor to move the fuel from the fuel tank to the agricultural machine; nevertheless, it is laborious and inefficient to refuel the agricultural machine by means of the manual operation.

In order to promote the refueling efficiency, the cultivator may install a refueling apparatus in each one of the fuel tanks, but the installation cost of the refueling apparatus is so high that the cultivator has to consider the number of the fuel tanks. If the number of the fuel tanks is too much, the installation cost will be increased, but if the number of the fuel tanks is too little, the refueling operation will be inconvenient. Thus, it is a need to provide an improved refueling apparatus that does not have the aforesaid drawbacks.

### SUMMARY OF THE INVENTION

The present invention has been accomplished in view of the above-noted circumstances. It is one objective of the present invention to provide a portable electrical liquid dispensing apparatus, which can provide an efficient, laborsaving, and convenient refueling operation.

It is another objective of the present invention to provide a portable electrical liquid dispensing apparatus, which can reduce the installation cost.

To achieve these objectives of the present invention, the portable electrical liquid dispensing apparatus comprises a housing, a power supply detachably connected with the housing, a driving unit accommodated in the housing and electrically connected with the power supply, a liquid dispensing unit accommodated in the housing and coupled to the driving unit, a first dispensing pipe having a first entry end, a first valve at the first entry end, and a first exhaust end connected with the liquid dispensing unit, and a second dispensing pipe having a second entry end connected with the liquid dispensing unit, a second exhaust end, and a second valve at the second exhaust end.

As a result, a cultivator doesn't need to install a conventional refueling apparatus in each one of fuel tanks for reducing the installation cost, but can take the electrical liquid dispensing apparatus of the present invention to any one of the fuel tanks to refuel a agricultural machine, thereby enhancing the efficiency and convenience of refueling operation.

The scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become fully understood from the detailed description given herein below and the accompanying drawings which are given by way of illustration only, and thus are not limitative of the present invention, and wherein:

FIG. 1 is a schematic drawing of a portable electrical liquid dispensing apparatus according to a preferred embodiment of the present invention.

FIG. 2 is a sectional view of the first valve of the portable electrical liquid dispensing apparatus according to a preferred embodiment of the present invention, showing the first valve is opened, and

FIG. 3 is similar to FIG. 2, but showing the first valve is closed.

### DETAILED DESCRIPTION OF THE INVENTION

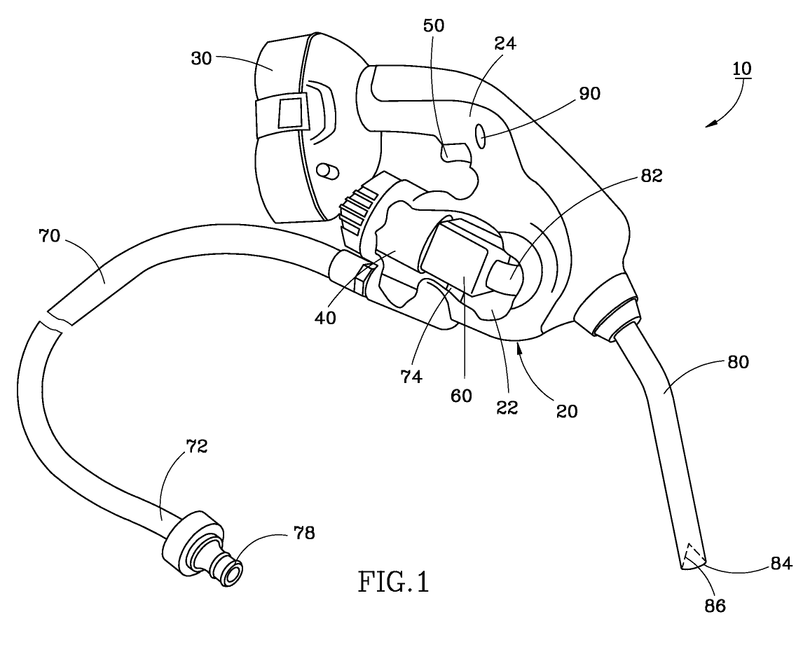

As shown in FIG. 1, a portable electrical liquid dispensing apparatus 10 in accordance with a preferred embodiment of the present invention comprises a housing 20, a power supply 30, a driving unit 40, a trigger 50, a liquid dispensing unit 60, a first dispensing pipe 70, and a second dispensing pipe 80.

The housing 20 has an accommodation portion 22 and a holding portion 24.

The power supply 30, which is embodied as a battery, such as the lithium battery, the nickel-metal hydride battery, or the nickel-cadmium battery, is detachably connected with a bottom of the holding portion 24 of the housing 20.

The driving unit 40, which is embodied as a brushless motor, is accommodated in the accommodation portion 22 of the housing 20 and electrically connected with the power supply 30.

The trigger 50 is installed on the housing 20 and electrically connected with the driving unit 40 such that the trigger 50 can be pressed by an external force to start the driving unit 40.

The liquid dispensing unit 60, which is embodied as a pump, is accommodated in the accommodation portion 22 of the housing 20 and electrically connected with the driving unit 40 such that the liquid dispensing unit 60 can be driven by the driving unit 40 to dispensing the fuel.

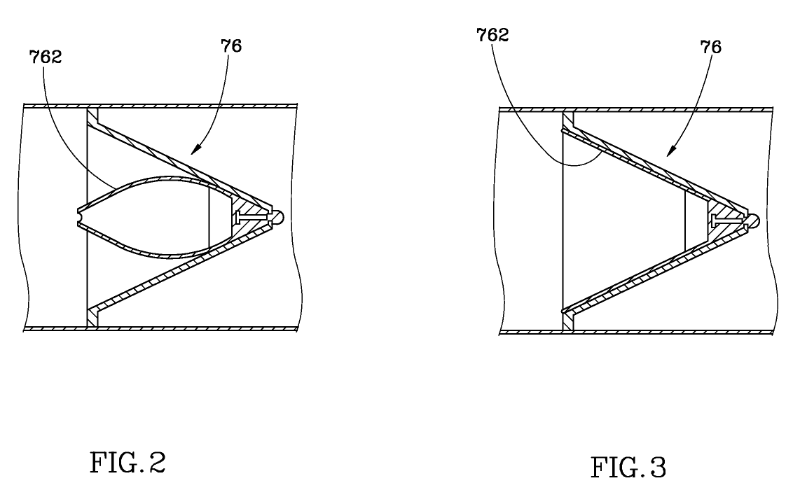

The first dispensing pipe 70 has a first entry end 72, a first exhaust end 74 connected with the liquid dispensing unit 60, a first valve 76 at the first entry end 72, and a male quick release connector 78 connected to the first entry end 72 for connecting a female quick release connector (not shown) of a fuel tank (not shown). The first valve 76 is embodied as a diaphragm check valve, having a flexible diaphragm 762 to allow the free passage of the fuel when the diaphragm 762 is deflected, as shown in FIG. 2, and prevent the back flow of the fuel when the diaphragm 762 returns to its original position, as shown in FIG. 3.

The second dispensing pipe 80 has a second entry end 82 connected with the liquid dispensing unit 60, a second exhaust end 84 insertable into a fuel tank filler opening of a agricultural machine such that the liquid dispensing unit 60 can move the fuel into the agricultural machine through the second dispensing pipe 80 for refueling, and a second valve 86 at the second exhaust end 84. The second valve 86 has the same type as the first valve 76 so that no further detailed description in this regard is necessary.

By means of the aforesaid design, when the agricultural machine needs to be refueled, a cultivator can operate the agricultural machine to any one of the fuel tanks, and then connect the male quick release connector 78 of the electrical liquid dispensing apparatus 10 and the female quick release connector of the fuel tank with each other. As a result, the cultivator can press the trigger 50 to start the liquid dispensing unit 60 through the driving unit 40 to dispensing the fuel from the fuel tanks into the agricultural machine through the first dispensing pipe 70 and the second dispensing pipe 80. During the refueling operation, the first valve 76 can prevent back flow of the fuel through the flexible diaphragm 762 when the fuel enters the first dispensing pipe 70, and the second valve 86 can allow the outflow of the fuel under pressure. After the refueling operation is completed, the cultivator can release the trigger 50 and disconnect the male quick release connector 78 of the electrical liquid dispensing apparatus 10 from the female quick release connector of the fuel tank, and then proceed to operate the agricultural machine to cultivate the land.

Accordingly, the cultivator can take the electrical liquid dispensing apparatus 10 of the present invention to any one of the fuel tanks and refuel the agricultural machine effortlessly by means of the electric power, thereby enhancing the efficiency and convenience of refueling operation; moreover, the cultivator can built adequate fuel tanks around the land without installing a conventional refueling apparatus in each one of the fuel tanks, thereby reducing the installation cost.

To deserve to be mentioned, the electrical liquid dispensing apparatus 10 of the present invention may include a control unit 90. The control unit 90 is mounted on the housing 20 and electrically connected with the driving unit 40 to operate the driving unit 40. When the driving unit 40 rotates in forward direction, the liquid dispensing unit 60 can move the fuel from the fuel tanks into the agricultural machine through the first dispensing pipe 70 and the second dispensing pipe 80.

The invention being thus described, it will be obvious that the same may be varied in many ways. Such variations are not to be regarded as a departure from the spirit and scope of the invention.

What is claimed is:

1. A portable electrical liquid dispensing apparatus comprising:
a housing;
a power supply detachably connected with said housing;
a driving unit accommodated in said housing and electrically connected with said power supply;
a liquid dispensing unit accommodated in said housing and coupled to said driving unit;
a first dispensing pipe having a first entry end, a first valve at said first entry end, and a first exhaust end connected with said liquid dispensing unit; and
a second dispensing pipe having a second entry end connected with said liquid dispensing unit, a second exhaust end, and a second valve at said second exhaust end.

2. The portable electrical liquid dispensing apparatus as claimed in claim 1, further comprising a trigger installed on said housing and electrically connected with said driving unit.

3. The portable electrical liquid dispensing apparatus as claimed in claim 1, further comprising a control unit mounted on said housing and electrically connected with said driving unit to operate said driving unit.

4. The portable electrical liquid dispensing apparatus as claimed in claim 1, further comprising a quick release connector connected to said first entry end of said first dispensing pipe.
